(19) United States
(12) Patent Application Publication
(10) Pub. No.: US 2024/0283182 A1
(43) Pub. Date: Aug. 22, 2024

(54) Female Electrical Receptacle

(71) Applicant: Leonard James Abbisso, Dedham, MA (US)

(72) Inventor: Leonard James Abbisso, Dedham, MA (US)

(21) Appl. No.: 18/441,411

(22) Filed: Feb. 14, 2024

Related U.S. Application Data
(60) Provisional application No. 63/446,313, filed on Feb. 16, 2023.

(51) Int. Cl. H01R 13/20; H01R 13/629

(52) U.S. Cl. CPC H01R 13/20; H01R 13/62966

(57) ABSTRACT

The present invention is a housing comprising of a female power receptacle. The housing may have one or more electrical contacts inside. The housing may have a raised flat, circular surface. Said raised surface may have one or more openings on it corresponding to the location of the electrical contacts inside. The raised circular surface may have a rotatable ring around it with wedge shaped features on its interior surface which, when rotated, apply pressure to elongated pins on the interior of the housing, which then apply pressure to the electrical contacts inside. In another embodiment the housing may have an outer sleeve which when moved along the housings longitudinal surface may apply pressure to the interior pins which may then apply pressure to the electrical contacts inside.

### CROSS-REFERENCES TO RELATED APPLICATIONS

NA

### REFERENCE TO FEDERALLY SPONSORED RESEARCH OR DEVELOPMENT

NA

### REFERENCE TO JOINT RESEARCH AGREEMENTS

NA

### REFERENCE TO SEQUENCE LISTING

NA

### BACKGROUND OF THE INVENTION

### Field of the Invention

The present invention generally relates to devices for use with electrical power connections, and, in particular, relates to male and female connectors, and, in greater particularity, relates to means for connecting a male connector and to a female receptacle in a method that provides a tight electrical connection, and, kept securely in place but also having them readily disconnect-able without excessive force needed.

### Description of the Prior Art

When making temporary electrical connections, it is important that the electrical contacts remain tight to reduce the instance of overheating or inadvertent disconnection, yet remain readily disconnect-able in the event of an electrical failure or other emergency. One problem that occurs is the nuisance disconnection of the male electrical connector from the female receptacle when the receptacle becomes worn and loose due to normal wear and tear. This could also become a hazardous condition if the power connection is feeding essential equipment such as lighting or other equipment. A second problem that occurs is the overheating of the electrical connection when the contacts become worn and loose due to wear and tear therefore prone to overheating resulting in fire hazard. To prevent these types of possible problems, for example, is to have the connection remain tight and secure yet continue to be readily disconnect-able.

U.S. Pat. No. 9,496,648B1 shows an extension cord female socket with a locking device. While this invention accomplishes a similar result, it does so by applying pressure to the contacts from an internal position, using an external sliding mechanism. Further, U.S. Pat. No. 3,710,304A also accomplishes a similar result of applying pressure to the contacts using an internal lever method and external push buttons. Further, U.S. Pat. No. 8,545,251B2 shows a locking female receptacle using a rotatable outer housing however, the housing interacts with clevis pins which are inserted through apertures in the male electrical contact after it is inserted. This configuration relies on the male electrical contact having apertures where many older male electrical contacts exist which do not have these apertures rendering this configuration limited in its use. Further, this design also does not apply pressure to the actual electrical contact points which completely ignores the wear and tear issue of overheating when compared to the present invention. The National Electrical Code also recognizes these types of cord and plug connections as disconnecting means. This device requires a two handed operation which, in the event of an emergency, could create a dangerous situation such as if you have one hand caught in the machine you are trying to disconnect. Still further, U.S. Pat. No. 3,891,289A accomplishes the same result of applying pressure on the internal electrical contacts however, it uses a screw method.

I have identified another existing product that I could not find a patent related to. It is advertised under the PROLOCK brand name and is easily found during an internet search. It is a locking female extension cord and also the female cap alone for replacement purposes. This design uses the clevis pin type operation in a similar operation as U.S. Pat. No. 8,545,251B2, referenced above, by utilizing an outer sleeve that slides longitudinally along its housing to engage and disengage. This product also relies on two handed operation as well advertises requiring 80 pounds of pressure to release the male connector when locked. This further highlights the inherent danger of using such a product.

All references are incorporated herein as to their teachings.

Accordingly, there is a need for a device for an electrical connection which remains tight and secure, yet allows it to be readily disconnected.

### SUMMARY OF THE INVENTION

The present invention is directed at a male-female electrical connection that remains tight and secure in place.

A unique female receptacle that allows the male-female connection to maintain tight electrical contact and stay secured in place. Having the male connector remain tight and secure yet readily disconnect-able is critical to addressing problems with overheating and nuisance disconnections resulting in possible hazardous conditions.

The device of the present invention, in one embodiment, is for the connection of a female receptacle and a male electrical connector in a tight and secure manor; and the device may be one or more female receptacles having a single molded plastic body or formed metal housing with each having one or more electrical contacts inside. One side may have a raised surface. Further, said raised surface may be round. Further, the raised round surface may have one or more openings corresponding to the electrical contacts inside. Further, the raised circular surface may have a rotatable ring around it. The rotatable ring may also have one or more areas on its internal surface that are wedge shaped. When the rotatable ring is rotated the wedge may then interact with one or more elongated pins inside tubular spaces inside the housing located at a right angle to the electrical contacts inside the housing. This interaction may then cause pressure on the electrical contacts inside thereby applying pressure to the male electrical connector when it is inserted to the female receptacle. In another embodiment, the device may have a lever on the exterior of the housing that applies pressure to the pins when rotated 180 degrees. In an alternative embodiment, the housing may have an exterior sleeve around the housing that, when moved along it longitudinal axis, applies pressure to the internal pins.

One object of the present invention is to provide a device that maintains a secure connection which reduces nuisance and potentially hazardous conditions due to inadvertent disconnections;

It is another object of the present invention to provide a device that may maintains tight electrical contact over time in order to reduce overheating problems due to wear and tear;

It is a further object of the present invention to provide a design that may accommodate many different male-female electrical connection configurations;

It is yet a further object of the present invention to provide a device that may allow a readily disconnect-able connection;

It is still a further object of the present invention to provide a device that is easily manufactured and inexpensive;

These and other objects, features, and advantages of the present invention will become more readily apparent from the attached drawings and the detailed description of the preferred embodiments, which follow.

### BRIEF DESCRIPTION OF THE DRAWINGS

FIG. 1 is one embodiment of the present invention that shows a frontal cut away view of a single female receptacle with an exterior rotatable ring 4 having raised ridges 8 on its exterior surface and wedges 5 on its interior surface, and internal pins 7 inside tubular spaces 6 located at a right angle to the electrical contacts 2; the body 1 further shows a round raised surface 3 having openings 9 exposing electrical contacts 2; the wedges 5 on the interior surface of the outer ring 4 as illustrated will come into contact with the internal pins 7, when rotated as someone skilled in the art would understand, compressing them against the internal electrical contacts 2.

FIG. 2 is a side cross sectional view of FIG. 1 showing single female receptacle on the body 1 with a rotatable ring 4 with directional arrows 10 on its outer surface and pins 7 at a second right angle to the metal contacts 2;

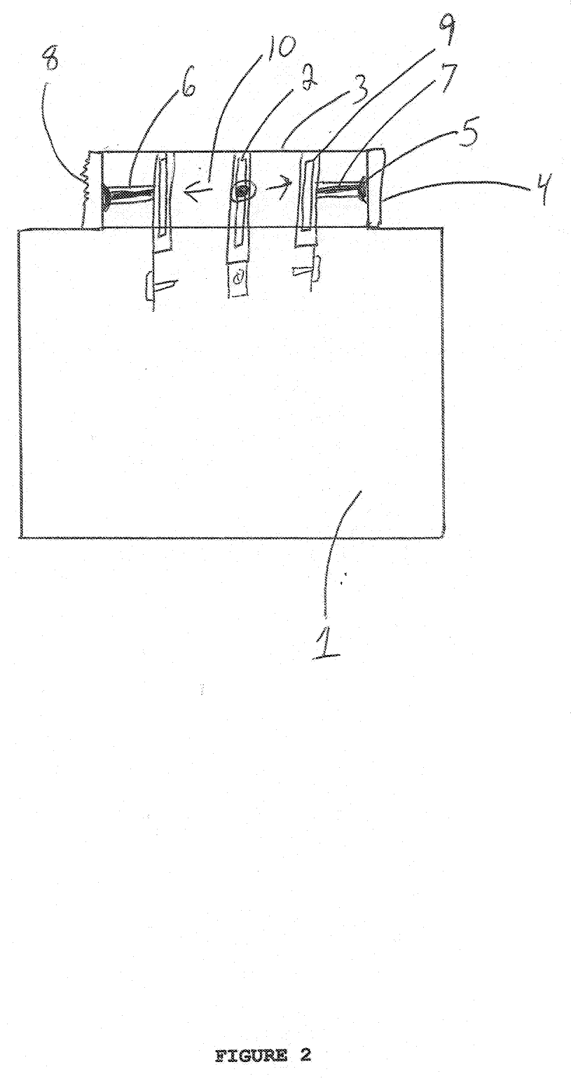

FIG. 3 is another embodiment of the present invention that shows an outer sleeve 11 that when manually moved along the longitudinal axis of the round raised part of the body 3 compresses the pins 7 against the electrical contacts 2 inside;

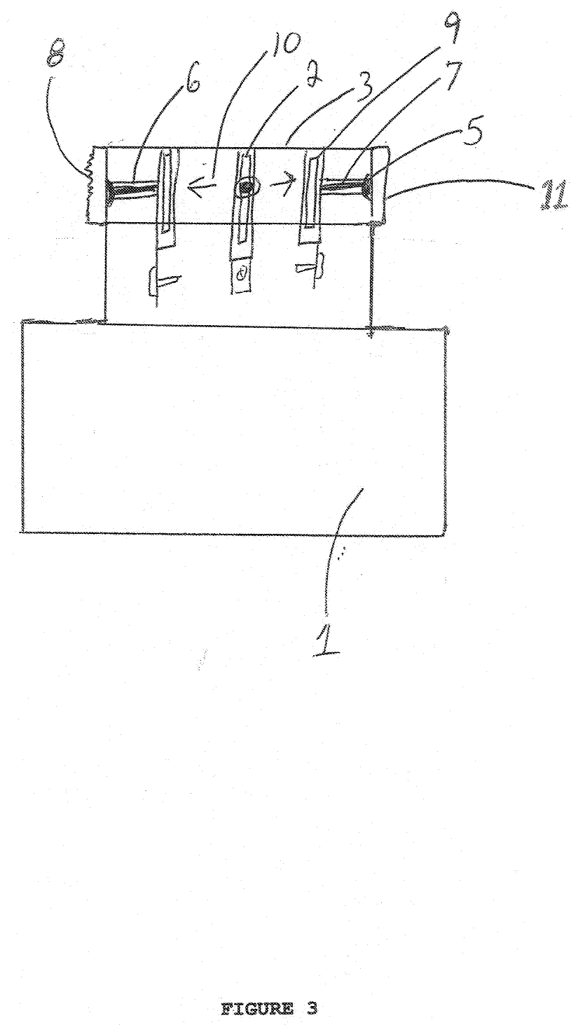

FIG. 4 is another embodiment of the present invention that shows levers with elongated base 12 positioned over the internal pins and attached with hinge points 13 on the outer surface of the round raised part of the body 3, that when pivoted 180 degrees apply pressure to the internal pins 7.

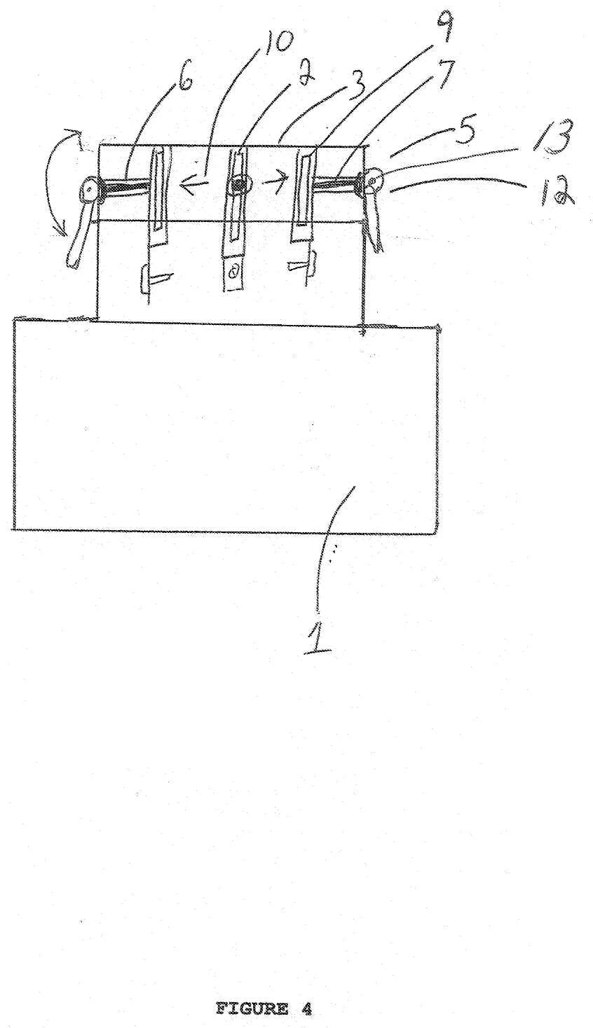

Like reference numerals refer to like parts throughout the several views of the drawings.

### DETAILED DESCRIPTION OF THE PREFERRED EMBODIMENTS

The present invention provides a unique female electrical receptacle for securely connecting a male electrical connector and maintaining a tight electrical connection.

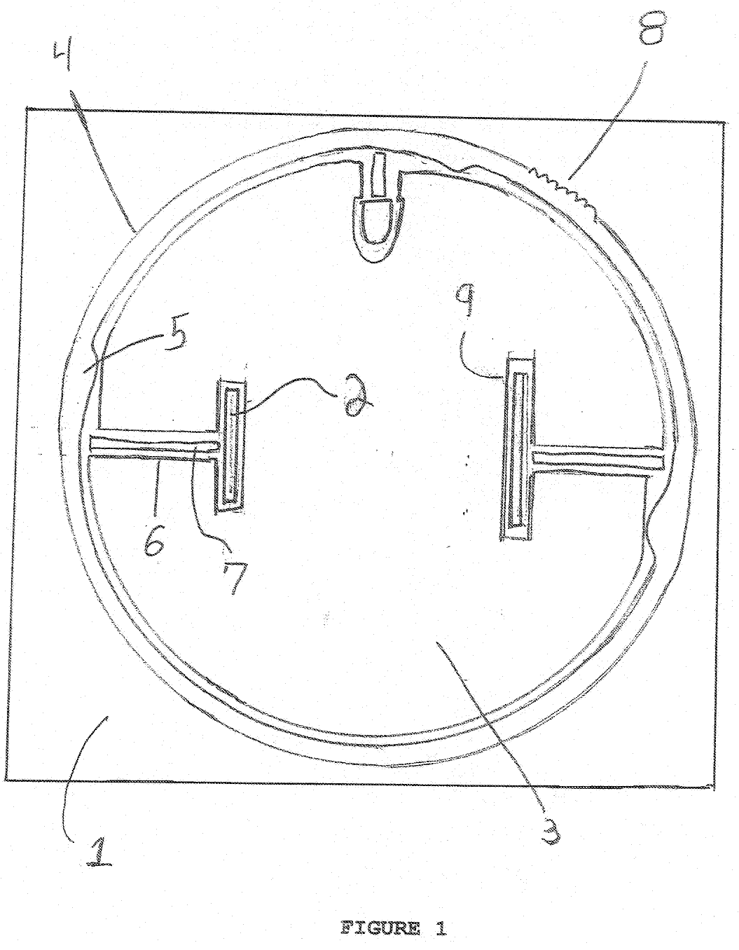

Referring to FIG. 1, a device body 1 for securing a male electrical contact in a secure manor and maintaining a tight electrical connection is shown in front view. The device has an electrical contact 2 accessed by the opening 9 in the flat raised circular surface of the body 3. A rotatable ring 4 with wedges 5 on its interior surface, and ridges 8 and directional arrows 10 on its exterior surface, when rotated, interact with the elongated pins 7 which are positioned inside the tubular spaces 6. When the rotatable ring 4 is rotated the wedge 5 on its interior surface compress against the elongated pins 7 that are housed in the tubular space 6 which in turn compress the pins 7 against the internal electrical contact 2. This compression provides resistance against the male electrical contact after it is inserted into the female receptacle and locked while simultaneously providing a secure insertion of the male electrical contact as well as maintaining a tight electrical connection between the male and female electrical contacts. The raised ridges 8 on the exterior of the rotatable ring 4 may allow ease of operation. The body 1 and outer ring 4 of the receptacle may be molded from plastic and formed using metal, for ease of manufacturer, both known conventionally. The elongated pins may be made of a non- conductive material or conductive material and encapsulated in a non-conductive material as would be needed as shown and understood by one skilled in the art.

The present invention is pictured in a NEMA 5-15R configuration however, there are numerous configurations of male-female temporary electrical connectors available for different applications. All of them being compatible with the present invention design features set forth here however, since many modifications, variations, and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents and not limited by the illustrated embodiments.

What is claimed is:

1. A device for making an electrical connection that stays securely in place and simultaneously maintains tight electrical contact between the male and female contacts that is also readily disconnect-able, said device comprising:
a female electrical receptacle having internal electrical contacts, may have a rotatable outer ring and internal pins positioned at a right angle to the internal electrical contacts that may apply pressure to the internal electrical contacts there by securing them in place and maintaining a tight electrical contact.

2. A device as defined in claim 1, said device comprising: a female electrical receptacle, said female receptacle having one or more internal electrical contacts, said female receptacle having a raised flat side, said raised flat side having openings corresponding to the electrical contacts inside, further, said raised flat side being circular in shape and having an exterior rotatable ring that may have one or more wedge shaped surfaces on it interior side formed to be a female receptacle.

3. The device as claimed in claim 2 further including one or more internal tubular space's located at a right angle to the internal electrical contacts and extending between the internal electrical contacts and the outer rotatable ring.

4. The device as defined in claim 3 further including elongated pins located inside said tubular space's, that extend the length of the tubular space so that when the rotatable ring is rotated the wedges on the internal side of the rotatable ring come into contact with the elongated pins housed within the internal tubular spaces and compress said pins against the internal electrical contacts.

5. Said device as defined in claim 1 further including directional arrows upon exterior side the rotatable ring.

6. Said device as defined in claim 1 further may include an outer sleeve that interacts with the internal pins.

7. Said device as defined in claim 1 may also use a lever attached to the body with pivot point positioned over the internal pins that apply pressure to the pins when rotated 180 degrees.
